(19) United States
(12) Patent Application Publication
(10) Pub. No.: US 2005/0215128 A1
(43) Pub. Date: Sep. 29, 2005

(54) Remote device probing for failure detection

(75) Inventors: Lior Levy, Jerusalem (IL); Jose Carlos Benchimol, Jerusalem (IL)

Correspondence Address: KONRAD RAYNES & VICTOR, LLP, Suite 210, 315 S. Beverly Drive, Beverly Hills, CA, 90212, US

(73) Assignee: Intel Corporation

(21) Appl. No.: 10/798,698

(22) Filed: Mar. 10, 2004

(51) Int. Cl. H01R 33/945

(52) U.S. Cl. 439/894

(57) ABSTRACT

Data is transmitted through a plurality of adaptors connected to switches. At least one query is sent through the adaptors to the switches connected to the adaptor to determine a status of external ports in each queried switch communicating with a network. In response to determining from the at least one query that no external ports are operational in one non-operational switch, indication is made not to transmit data to the adaptor connected to the non-operational switch.

### BACKGROUND

1. Field

The present embodiments relate to remote device probing for failure detection.

2. Description of the Related Art

A server may include multiple network adaptors to provide redundant communication paths to a network, where each adaptor is connected to a different switch providing a separate communication path to the network. A device driver in the server may manage the adaptors as a team and perform load balancing operations when transmitting data to the network. If the device driver detects that one adaptor has failed, then the device driver may perform a failover to the surviving adaptor to use only the surviving adaptor, and subsequently failback to using an adaptor that has recovered from a failed state.

### BRIEF DESCRIPTION OF THE DRAWINGS

Referring now to the drawings in which like reference numbers represent corresponding parts throughout:

FIG. 1 illustrates a chassis including different modular electronic circuit boards, such as in a blade server as known in the prior art;

FIGS. 2 and 3 illustrate a server and switch modular circuit boards, respectively, in accordance with embodiments;

FIG. 4 illustrates information about connected switches in accordance with embodiments; and

FIG. 5 illustrates operations performed to detect and handle a failure of connected switches in accordance with embodiments.

### DETAILED DESCRIPTION

In the following description, reference is made to the accompanying drawings which form a part hereof and which illustrate several embodiments. It is understood that other embodiments may be utilized and structural and operational changes may be made without departing from the scope of the embodiments.

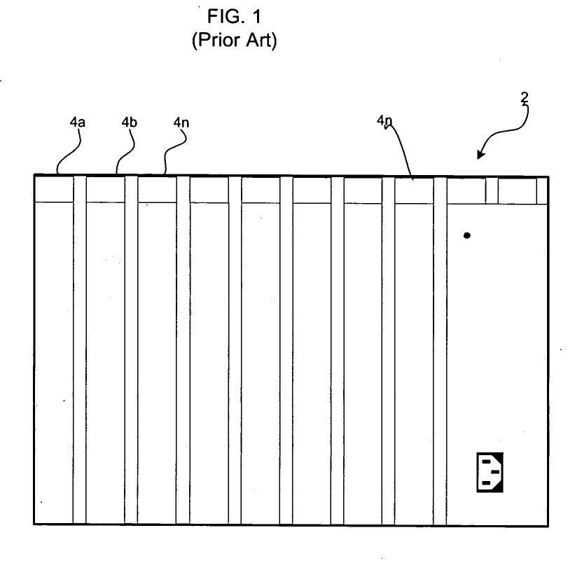

FIG. 1 illustrates a prior art representation of a blade server 2 chassis that includes a plurality of modular electronic circuit boards comprising computing devices 4a, 4b, 4c . . . 4n, also referred to as blades. The chassis 2 includes bays in which the blade boards may be inserted. The blade systems may comprise servers, switches, storage devices, etc., where each blade comprises a printed circuit board and processing units for performing the operations of that blade.

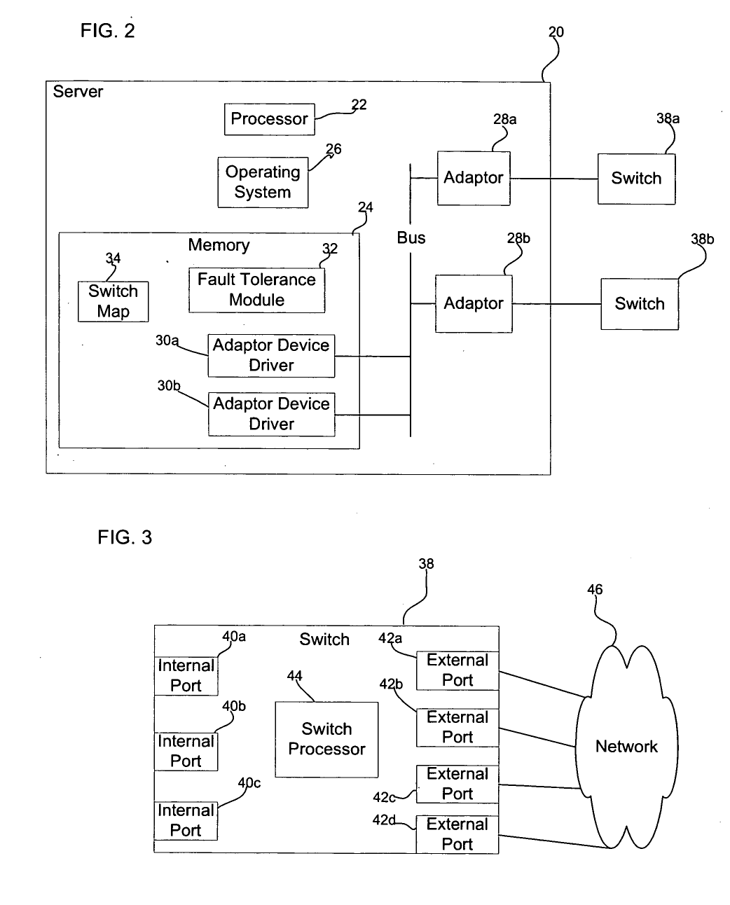

FIG. 2 illustrates a component architecture of a blade server 20, having a processor 22, which may comprise one or more central processing units (CPU), a volatile memory 24, an operating system 26, and adaptors 28a, 28b which include physical interfaces, such as a network interface card (NIC), to connect with remote devices comprising end devices, switches, expanders, storage devices, servers, etc. Device drivers 30a and 30b execute in the memory 24 to provide an interface between the operating system 26 and the adaptors 28a, 28b and perform such operations as managing interrupts, making device calls to control the adaptors 28a, 28b, and transmitting packets to the adaptors. One device driver 30a or 30b may manage multiple adaptors, and there may be separate device drivers 30a, 30b for different groups of one or more adaptors, where each device driver 30a, 30b is provided for an adaptor from a different vendor. A fault tolerance module 32 comprises an intermediate driver between the device drivers 30a, 30b and the operating system 26 and manages operations among the device drivers 30a, 30b. For instance, the fault tolerance module 32 may manage the adaptors 28a, 28b as a team and perform load balancing operations to distribute packets to the different device drivers 30a, 30b to transmit to their respective adaptors 28a, 28b to optimize throughput and performance. The fault tolerance module 32 may further handle failure and recovery of adaptors 28a, 28b by performing failover and failback operations. The fault tolerance module 32 maintains a switch map 34 which provides information on switches to which the adaptors 28a, 28b connect, including the status of external ports in each connected switch. The device drivers 30a, 30b communicate with the adaptors over a bus interface 36, comprising bus interface technologies known in the art.

Each adaptor 28a, 28b connects to a separate switch 38a, 38b, where the switches may comprise blades 4a, 4b . . . 4n or printed circuit boards in the same chassis 2 including the server blade 20, or comprise switches in separate chassis.

FIG. 3 illustrates components within a switch 38, such as switches 38a, 38b. The switch includes internal ports 40a, 40b, 40c to connect to local devices, such as the adaptors 28a, 28b in the blade server 20 and external ports 42a, 42b, 42c, 42d to connect to an external network 46. The switch 38 further includes a switch processor 44 to perform switch operations and route packets between the internal 40a, 40b, 40c and external 42a, 42b, 42c, 42d ports.

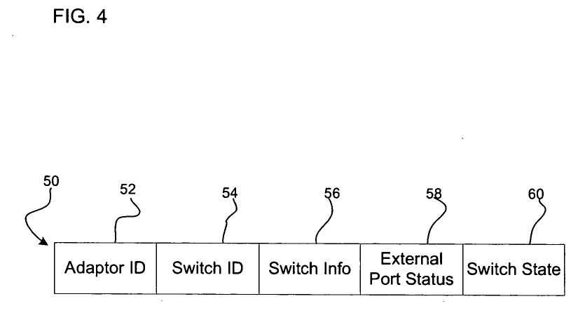

FIG. 4 illustrates information maintained by the fault tolerance module 32 that may be included in an entry 50 in the switch map 34, including an adaptor identifier (ID) 52 identifying an adaptor 28a, 28b (FIG. 2) and a switch ID 54 identifying a switch 38a, 38b to which the identified adaptor 28a, 28b connects. Switch information 56 includes additional information on the switch such as an IP address. The external port status 58 provides the status of each external port 42a, 42b, 42c, 42d in the switch having switch ID 54. If at least one external port 42a, 42b, 42c, 42d on the switch is functioning, then the switch state 60 is operational, otherwise, if no external ports 42a, 42b, 42c, 42d are operational, then the switch state 60 is non-operational.

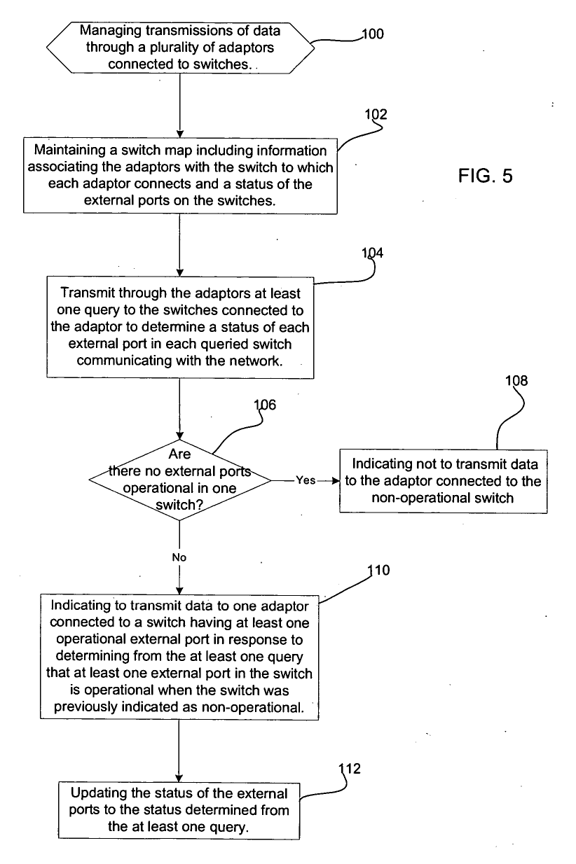

FIG. 5 illustrates operations performed by the fault tolerance module 32 to monitor the connected switches 38a, 38b. The fault tolerant module 32 manages (at block 100) transmissions of data through a plurality of adaptors connected to switches, such as the transmission of packets through adaptors 28a, 28b to switches 38a, 38b. The fault tolerant module 32 communicates with the adaptors 28a, 28b by issuing calls to the adaptor device drivers 30a, 30b. The fault tolerant module 32 may manage the adaptors 28a, 28b as a team and perform load balancing when transmitting packets to the adaptors 28a, 28b. The fault tolerant module 32 maintains (at block 102) a switch map 34 including information associating each adaptor 28a, 28b with the switch 38a, 38b to which the adaptor connects and a status of the external ports, e.g., 42a, 42b, 42c, 42d, on the attached switch. The fault tolerant module 32 transmits (at block 104), via the adaptor device drivers 30a, 30b, to each adaptor 28a, 28b at least one query to the switch 38a, 38b to which the adaptor connects to determine a status of each external port in the queried switch 38a, 38b communicating with the network 46. The fault tolerant module 32 may periodically query the connected switches 38a, 38b.

In certain embodiments, the fault tolerant module 32 queries the switches 38a, 38b using the Simple Network Management Protocol (SNMP). For instance, in certain embodiments, the switch processor 44 may operate as an SNMP agent and include a Management Information Base (MIB) providing information on the switch 38. The fault tolerant module 32, operating as an SNMP manager, may look-up the port link status of the switch external ports 42a, 42b, 42c, 42d using the SNMP command “ifOperStatus” to determine the value of the Object Identifier Description (OID) 1.3.6.1.2.1.2.2.1.8, providing the current operational state of an interface. The returned states may indicate whether operational packets can be passed. In additional embodiments, the fault tolerant module 32 may use additional or alternative communication protocols and commands to determine the state of the external ports in the switch. The SNMP protocol is described in the publications “Management Information Base for Network Management of TCP/IP-based Internets: MIB-II”, Network Working Group, RFC 1213 (March 1991) and “A Simple Network Management Protocol (SNMP)”, Network Working Group RFC1157 (May 1990).

Further, if two adaptors are connected to a same switch, then the fault tolerant module 32 may only query the status of the external ports on the connected switch 38a, 38b for one adaptor 28a, 28b. In certain embodiments though, each adaptor may be connected to a different switch to provide redundant paths to the network.

If (at block 106) there are no operational external ports in one switch 38a, 38b, then the fault tolerant module 32 indicates (at block 108) not to transmit data to the adaptor 28a, 28b connected to the non-operational switch 38a, 38b. If the adaptor 28a, 28b is in the non-operational state, then a failover may occur if the adaptor is indicated as the primary adaptor for all traffic. However, if (at block 110) there is at least one operational external port 42a, 42b, 42c, 42d, then the fault tolerant module 32 indicates to transmit data to one adaptor 28a, 28b connected to a switch 38a, 38bhaving at least one operational external port in response to determining from the at least one query that at least one external port in the switch is operational when the switch was previously indicated as non-operational. The status of the external ports is updated (at block 112) to the status determined from the at least one query.

In further embodiments, a failover occurs to the switch that is operational from the switch that is non-operational in response to determining from the at least one query that the switch is non-operational at block 108 and a failback is performed to the switch that is determined to have at least one operational external port when the switch was previously indicated as non-operational at block 110.

With the described embodiments, fault tolerant module 32 avoids sending packets to a functioning adaptor that is connected to a switch not having operational links to the external network. In described embodiments, the fault tolerant module 32 maintains a switch map 34 providing information on the status of the switch, which is used when determining an adaptor on which to transmit packets so that packets are only transmitted through adaptors connected to functioning switches. In alternative embodiments, the adaptor device drivers may update the switch map 34.

### Additional Embodiment Details

The described embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the embodiments, and that the article of manufacture may comprise any information bearing medium known in the art.

The described operations may be performed by circuitry, where “circuitry” refers to either hardware or software or a combination thereof. The circuitry for performing the operations of the described embodiments may comprise a hardware device, such as an integrated circuit chip, Programmable Gate Array (PGA), Application Specific Integrated Circuit (ASIC), etc. The circuitry may also comprise a processor component, such as an integrated circuit, and code in a computer readable medium, such as memory, wherein the code is executed by the processor to perform the operations of the described embodiments.

In the described embodiments, the server and switches comprise blades in a single chassis, where the switches provide connections to an external network. In alternative embodiments, the server and switches may be in separate chassis or boxes and connect through a direct line or over a network.

In described embodiments, the probing operations to determine the switch status are performed by the fault tolerant module. In alternative embodiments, the probing operations may be performed by the adaptor device drivers or a program module external to the fault tolerance module.

In described embodiments, the adaptors were connected to switches. In additional embodiments, the switches may comprise additional router or packet forwarding devices known in the art, such as an expander, etc.

FIG. 4 illustrates an example of information included in the switch map. Additionally, the information on the adaptors and switches connected thereto may be stored in a different format than shown in FIG. 4 with additional or less information on each connection between two devices and the information on the devices.

The illustrated operations of FIG. 5 shows certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

In blade server embodiments, the adaptors 38a, 38b may be implemented on a same printed circuit board, i.e., motherboard, including the server components. In additional embodiments, the adaptors 38a, 38b may be implemented on an expansion card that is mounted on the server 20 motherboard or backplane.

The foregoing description of various embodiments has been presented for the purposes of illustration and description. It is not intended to be exhaustive or to limit the embodiments to the precise form disclosed. Many modifications and variations are possible in light of the above teaching.

1. A method, comprising:
managing transmission of data through a plurality of adaptors connected to switches;
sending through the adaptors at least one query to the switches connected to the adaptor to determine a status of external ports in each queried switch communicating with a network; and
in response to determining from the at least one query that no external ports are operational in one non-operational switch, indicating not to transmit data to the adaptor connected to the non-operational switch.

2. The method of claim 1, further comprising:
maintaining a switch map including information associating the adaptors with the switch to which the adaptors connect and a status of the external ports on the switches; and
updating the status of the external ports to the status determined from the at least one query.

3. The method of claim 1, further comprising:
indicating to transmit data to one adaptor connected to one switch having at least one operational external port in response to determining from the at least one query that at least one external port in the switch is operational when the switch was previously indicated as non-operational.

4. The method of claim 3, further comprising:
performing a failover to the switch that is operational from the switch that is non-operational in response to determining from the at least one query that one switch is non-operational; and
performing a failback to the switch that is determined to have at least one operational external port when the switch was previously indicated as non-operational.

5. The method of claim 1, wherein the adaptors are managed as a team and wherein load balancing operations are performed when transmitting data through the adaptors.

6. The method of claim 1, wherein each adaptor is connected to a different switch to provide redundant paths to the network.

7. The method of claim 1, wherein the operations of managing the transmissions of data, sending the at least one query and indicating not to transmit data to one adaptor is performed by an intermediate device driver executing in a server in communication with adaptor device drivers, wherein each switch and the server are implemented on different printed circuit boards, and wherein the server and switch printed circuit board are in a chassis.

8. The method of claim 1, wherein the at least one query comprises an SNMP query of the external port link status.

9. A system in communication with at least one switch, wherein the switch communicates with a network, comprising:
a plurality of adaptors connected to the at least one switch;
circuitry capable of causing operations, the operations comprising:
(i) managing transmission of data through the adaptors;
(ii) sending through the adaptors at least one query to the switches connected to the adaptor to determine a status of external ports in each queried switch communicating with the network; and
(iii) in response to determining from the at least one query that no external ports are operational in one non-operational switch, then indicating not to transmit data to the adaptor connected to the non-operational switch.

10. The system of claim 9, further comprising:
a switch map including information associating the adaptors with the switch to which the adaptors connect and a status of the external ports on the switches, wherein the operations performed by the circuitry are further capable of updating the status of the external ports to the status determined from the at least one query.

11. The system of claim 9, wherein the operations performed by the circuitry are further capable of:
indicating to transmit data to one adaptor connected to one switch having at least one operational external port in response to determining from the at least one query that at least one external port in the switch is operational when the switch was previously indicated as non-operational.

12. The system of claim 9, wherein the operations performed by the circuitry are further capable of:
performing a failover to the switch that is operational from the switch that is non-operational in response to determining from the at least one query that one switch is non-operational; and
performing a failback to the switch that is determined to have at least one operational external port when the switch was previously indicated as non-operational.

13. The system of claim 9, wherein the adaptors are managed as a team and wherein load balancing operations are performed when transmitting data through the adaptors.

14. The system of claim 9, wherein each adaptor is connected to a different switch to provide redundant paths to the network.

15. The system of claim 9, wherein the circuitry for performing the operations of managing the transmissions of data, sending the at least one query and indicating not to transmit data to one adaptor is implemented as an intermediate device driver, further comprising:
at least one adaptor device driver in communication with the intermediate device driver managing communications to at least one adaptor.

16. The system of claim 9, further comprising:
a chassis, wherein the switches are implemented on printed circuit boards in the chassis; and
a printed circuit board in the chassis on which the circuitry and adaptors are implemented.

17. The system of claim 9, wherein the at least one query comprises an SNMP query of the external port link status.

18. A system in communication with a network, comprising:
(a) a chassis;
(b) a plurality of switch printed circuit boards capable of being inserted in the chassis;
(c) a server printed circuit board capable of being inserted in the chassis, and including:
(i) a plurality of adaptors connected to the switch printed circuit boards;
(ii) circuitry capable of causing operations, the operations comprising:
(A) managing transmission of data through the adaptors;
(B) sending through the adaptors at least one query to the switch printed circuit boards connected to the adaptor to determine a status of external ports in each queried switch communicating with the network; and
(C) in response to determining from the at least one query that no external ports are operational in one non-operational switch printed circuit board, then indicating not to transmit data to the adaptor connected to the non-operational switch printed circuit board.

19. The system of claim 18, wherein the server printed circuit board further includes:
a switch map including information associating the adaptors with the switch to which the adaptors connect and a status of the external ports on the switches, wherein the operations performed by the circuitry are further capable of updating the status of the external ports to the status determined from the at least one query.

20. An article of manufacture in communication with adaptors connected to switches, wherein the switches provide communication with a network, and wherein the article of manufacture is capable of causing operations to be performed, the operations, comprising:
managing transmission of data through the adaptors connected to the switches;
sending through the adaptors at least one query to the switches connected to the adaptor to determine a status of external ports in each queried switch communicating with the network; and
in response to determining from the at least one query that no external ports are operational in one non-operational switch, then indicating not to transmit data to the adaptor connected to the non-operational switch.

21. The article of manufacture of claim 20, wherein the operations further comprise:
maintaining a switch map including information associating the adaptors with the switch to which the adaptors connect and a status of the external ports on the switches; and
updating the status of the external ports to the status determined from the at least one query.

22. The article of manufacture of claim 20, wherein the operations further comprise:
indicating to transmit data to one adaptor connected to one switch having at least one operational external port in response to determining from the at least one query that at least one external port in the switch is operational when the switch was previously indicated as non-operational.

23. The article of manufacture of claim 22, wherein the operations further comprise:
performing a failover to the switch that is operational from the switch that is non-operational in response to determining from the at least one query that one switch is non-operational; and
performing a failback to the switch that is determined to have at least one operational external port when the switch was previously indicated as non-operational.

24. The article of manufacture of claim 20, wherein the adaptors are managed as a team and wherein load balancing operations are performed when transmitting data through the adaptors.

25. The article of manufacture of claim 20, wherein each adaptor is connected to a different switch to provide redundant paths to the network.

26. The article of manufacture of claim 20, wherein the operations are performed by an intermediate device driver in communication with adaptor device drivers.

27. The article of manufacture of claim 20, wherein the at least one query comprises an SNMP query of the external port link status.
